(19) United States
(12) Patent Application Publication
(10) Pub. No.: US 2008/0115417 A1
(43) Pub. Date: May 22, 2008

(54) Drive for movable furniture part

(76) Inventor: Edgar Huber, Hard (AT)

Correspondence Address: WENDEROTH, LIND & PONACK, L.L.P., 2033 K STREET N. W., SUITE 800, WASHINGTON, DC, 20006-1021, US

(21) Appl. No.: 12/010,050

(22) Filed: Jan. 18, 2008

Related U.S. Application Data
(63) Continuation of application No. PCT/AT06/00258, filed on Jun. 26, 2006.

(30) Foreign Application Priority Data
Jul. 20, 2005 (AT) A 1222/2005

(51) Int. Cl. E05F 15/16

(52) U.S. Cl. 49/349

(57) ABSTRACT

Drive (1) for a movable furniture part (7), comprising a motor (2) and an output (4) drivable by the motor (2) for the movable furniture part (7), a control or regulation unit (5) and a measuring device (6) for capturing the position and/or quantities of motion of the movable furniture part (7), wherein the measurement signals from the measuring device (6) can be transmitted to the control or regulation unit (5) and wherein a clutch (3) co-operating with the motor (2) and the output (4) is provided, the clutch (3) being designed such that it can be engaged and disengaged by the control and regulation unit (5), characterized in that the clutch (3) can be engaged and disengaged by the control and regulation unit (5) in dependence on the measurement signals from the measuring device (6).

The present invention relates to a drive for a movable furniture part, comprising a motor and an output drivable by the motor for the movable furniture part.

Although the idea of using motors to power movable furniture parts has long been known in principle, drives of this type are rarely used in practice. This partly due to the fact that motors, in case of an internal defect, can present an obstacle to the manual operation of the movable furniture part due to their inherent inertia. In such a case, the movable furniture part would be unusable until repaired, which obviously consumers find unacceptable.

The problem of the invention is therefore to create a generic drive which allows manual operation of the movable furniture part, even if there is a motor defect.

This problem is solved by a drive with the features of claim 1.

An engaged clutch in the sense of this disclosure means a clutch which is in a state in which it transmits forces between the motor and the output, so that there is an uninterrupted flow of power between motor and output. A disengaged clutch means a clutch which is in a condition in which no forces are transmitted between the motor and the output, so that the flow of power between motor and output is interrupted. An engaged clutch can also be described as a closed clutch and a disengaged clutch as an open clutch.

The engaging and disengaging clutch provided by the invention allows a defective motor to be separated from the outlet by disengaging the clutch, so that no inertia can be transferred from the motor to the outlet and thus to the movable furniture part. This enables uninterrupted manual operation of the movable furniture part.

Especially advantageous is one embodiment of the invention in which provision is made that the clutch is designed so that it can be engaged and disengaged by a control or regulation unit. In addition to the aforementioned function, with this embodiment a large number of other functions can also be realised through the possibility of controlling or regulating the clutch in normal operation, i.e. when there is no motor defect.

For example, the clutch can be designed such that the strength of the clutch force can be modified. In other words, at constant motor output, the amount of power transferred from the motor to the output can be modified. This allows, for example, gentle starting of the movable furniture part to be realised, in that the clutch is adjusted so that when the motor is started a slight racing (similar to the slipping of the clutch when starting a car) occurs. This function can be realised, for example, with a frictionally-engaging clutch.

In a clutch with variable strength of the clutch force, there can even be provision for the clutch to be designed such that the modification of the clutch force follows a pre-set profile when transitioning between the disengaged state and the engaged state. This makes it possible to realise different starting behaviours with a single motor, which also need have no further functions than on and off.

The clutch can, for example, be designed as an electromagnetic clutch. Such a clutch can also be designed such that it is disengaged in currentless condition. This ensures that, if there is a power cut, the motor cannot offer any resistance to manual operation of the movable furniture part.

For various reasons, in a further advantageous embodiment of the invention, provision can be made to dispose a measuring device to capture the position and/or quantities of motion, such as speed or acceleration, of the movable furniture part. As the result of this, the engaging and disengaging clutch can for example be controlled and/or regulated as a function of the measured values. In particular it is possible to make provision that the clutch can be engaged or disengaged by the control or regulation unit as a function of the measurement signals from the measuring device.

For example if an inventive drive is disposed on a piece of furniture which has a furniture part on the furniture body and a furniture part movable in or on the furniture body, a wide variety of functions can be realised.

For example, provision may be made that the control or regulation unit is designed so that it disengages the clutch when the movable furniture part is at a distance from the furniture body and displays a speed which is less than or equal to a pre-set value—preferably equal to zero. In this case, the movable furniture part is moved by the motor after an initial triggering by a user, into a position between the closed final position in or on the furniture body and the fully-open final position. This partial opening can be sufficient for items to be put into or taken out of the drawer.

The initial triggering can occur in various ways, for example via the actuation of a push-button or by pulling on the movable furniture part.

It is also possible to make provision that the control or regulation unit is designed such that if the movable furniture part is manually moved further in the direction of the fully-open end position, it leaves the clutch open. In this case, the motor serves only as a booster to overcome any automatic retraction devices which may be present, while in the aforementioned case it can exert forces on the movable furniture part over the entire opening path.

Provision may also be made that the control or regulation unit also starts the motor to support the closing process of the movable furniture part. For this, it can have a threshold value in relation to the quantities of motion of the movable furniture part transmitted by the measurement device, where the motion of the movable furniture part is triggered when the threshold value is exceeded. This threshold value can vary for at least two positions of the movable furniture part.

For example, provision can be made that the control or regulation unit triggers the retraction of the movable furniture part from the fully-open end position at a lower value of a force exerted from outside on the movable furniture part than when the movable furniture part is in an intermediate position between the closed end position and the fully-open end position. This is because when the movable furniture part is fully open, the intention of the user is clear. If the furniture part is partially-open, however, too low a threshold value could actuate triggering when items are being removed.

Provision may further be made that the movable furniture part is accelerated to a pre-set speed value after triggering.

If an automatic retraction device is provided, in addition to the drive, in a piece of furniture, which is designed such that it can retract the movable furniture part into the closed end position in or on the furniture body, provision may preferably be made that the control or regulation unit disengages the clutch as soon as the movable furniture part comes into range of the automatic retraction device. This is advantageous insofar as automatic retraction devices are already available which enable a closing process which is perceived by users as especially agreeable. By disengaging the clutch, the motor has no effect whatsoever, so that the movable furniture part can move into the closed end position under the influence of the automatic retraction device alone.

If a piece of furniture has a collision detection device for the movable furniture part, provision may additionally be made that the control or regulation unit is designed such that it disengages the clutch when the collision detection device reports a collision. This prevents any damage and/or injury due to a continuing effect of power of the motor in the event of a collision.

The measurement device can for example include an encoder, in which case inductive or optical encoders can equally be used. Although motors with integrated encoders are already available, an embodiment is preferred in which the encoder is coupled with the output. In this case, any change in position of the movable furniture part, even when the clutch is disengaged and in manual operation, will always be exactly captured.

The output can, for example, co-operate with the movable furniture part via a traction mechanism. This makes it possible for both traction and pressure forces to be exerted on the movable furniture part. A cable pull, a toothed belt or similar could for example be used as traction mechanism.

In one especially preferred embodiment of the invention provision is made that the motor, the clutch and the output are disposed along an imaginary line with the clutch disposed between motor and output. This enables a compact construction of the drive, as the result of which it can easily be disposed in the inside of the piece of furniture on the furniture body, for example between the rear wall of a drawer and the back wall of the furniture body.

An especially simple construction is produced when provision is made that a shaft is disposed along the line between motor and clutch on the one hand and between clutch and output on the other respectively. When the clutch is disengaged, i.e. open, only the part of the clutch disposed on the output side rotates when the movable furniture part is used manually. When the clutch is engaged, i.e. closed, the force is exerted by the motor on the output in such a way that the shaft disposed on the motor side drives the shaft disposed on the output side via the clutch.

Naturally, in order to attain different rotary speeds, provision can be made that the motor co-operates with the clutch by means of a gearbox.

Because of the low procurement costs, it is especially preferable to make provision for the motor to be in the form of an electromotor.

The proposed drive is especially suitable for a movable furniture part in the form of a drawer.

Protection is also required for a piece of furniture with a furniture body and a movable furniture part running in or on the furniture body, characterised by the arrangement of a drive according to one of the aforementioned embodiments.

Further advantages and details of the invention are shown by the figures and the following description of the figures, which show:

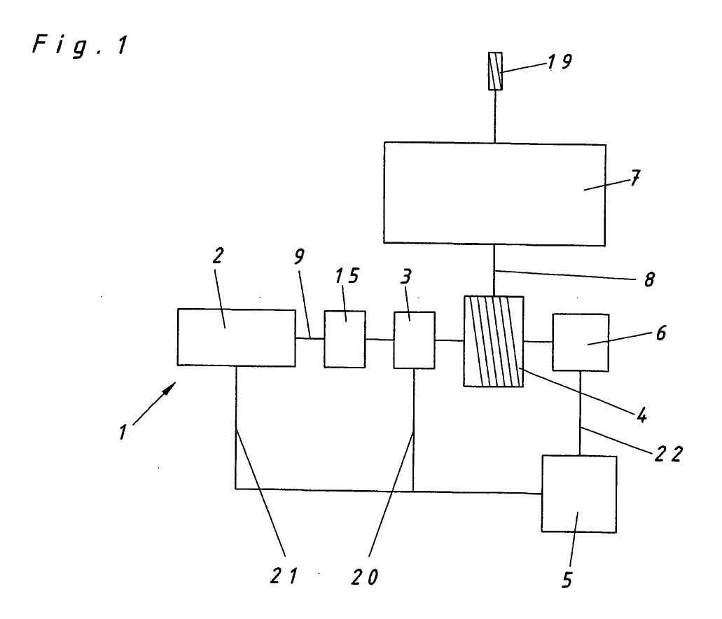

FIG. 1 a schematic view of an inventive drive,

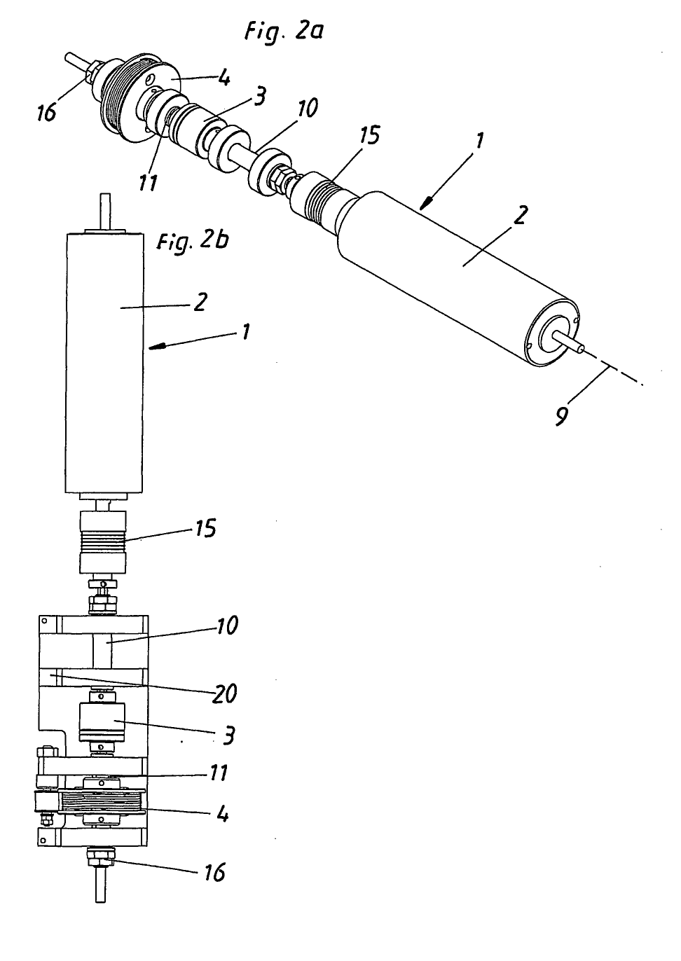

FIG. 2a, 2b a perspective view and a top view of an embodiment of an inventive drive,

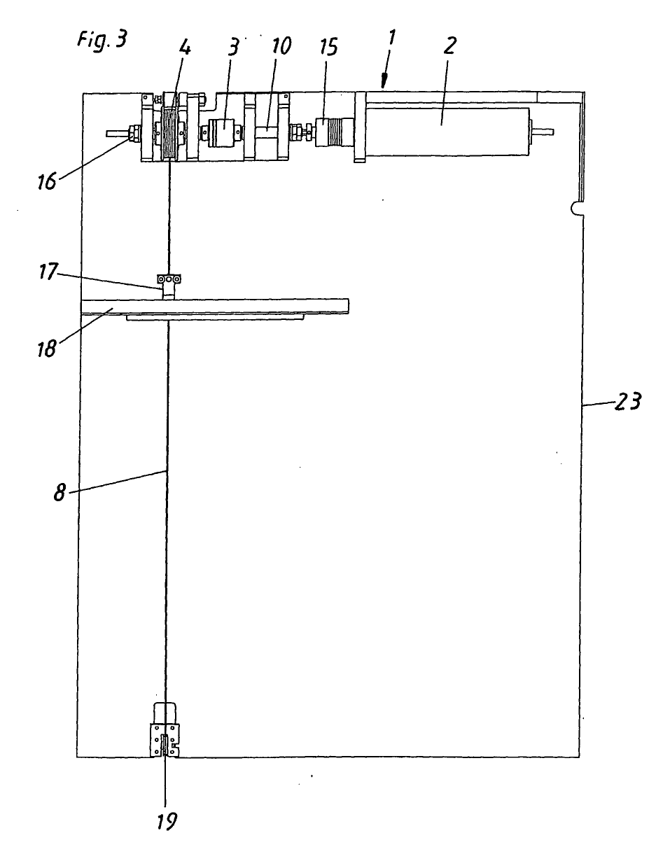

FIG. 3 top view of a furniture body with in-built drive,

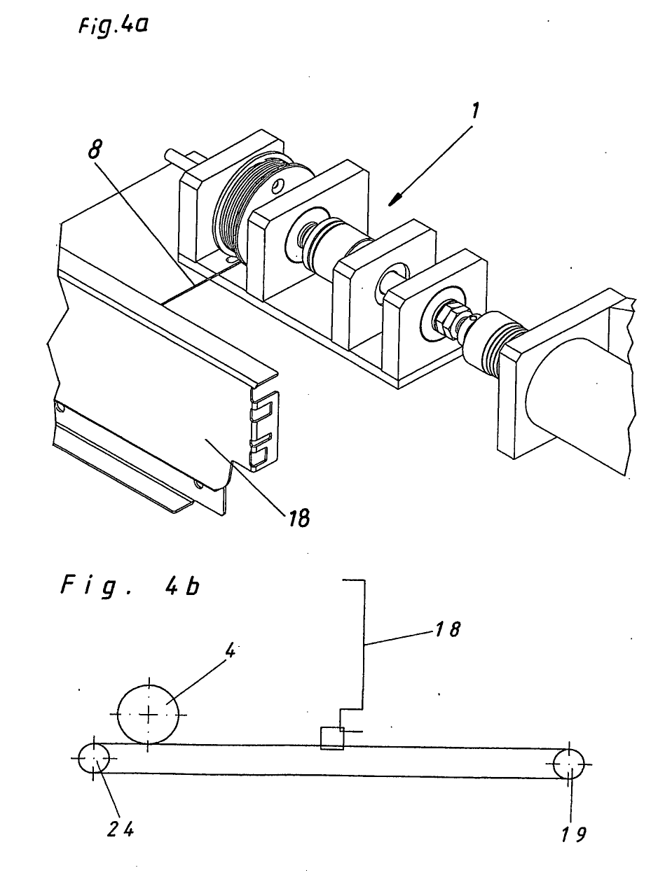

FIG. 4a, 4b a perspectival detail view of FIG. 3 and a schematic view of the course of the traction mechanism,

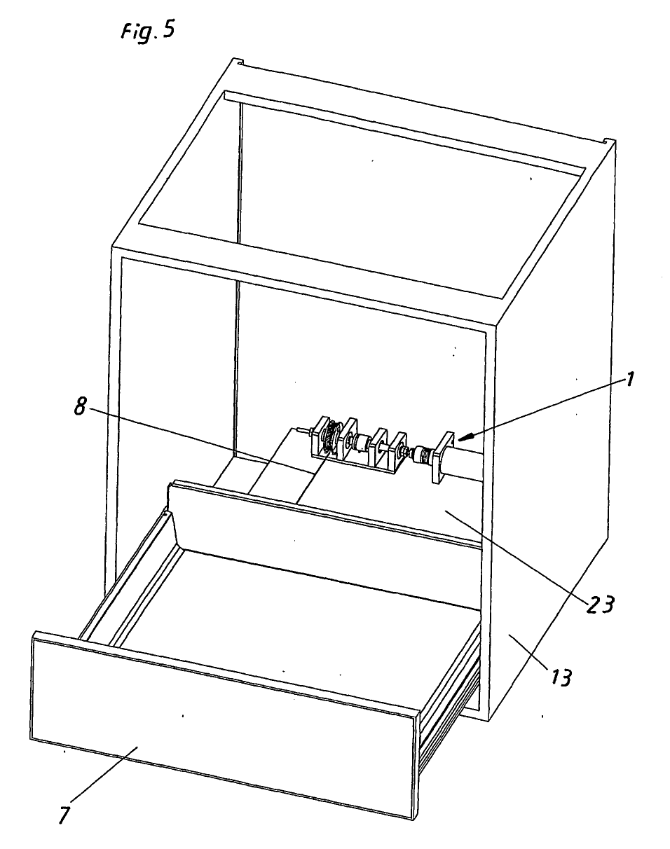

FIG. 5 a perspectival view of a piece of furniture with a drive according to the invention and

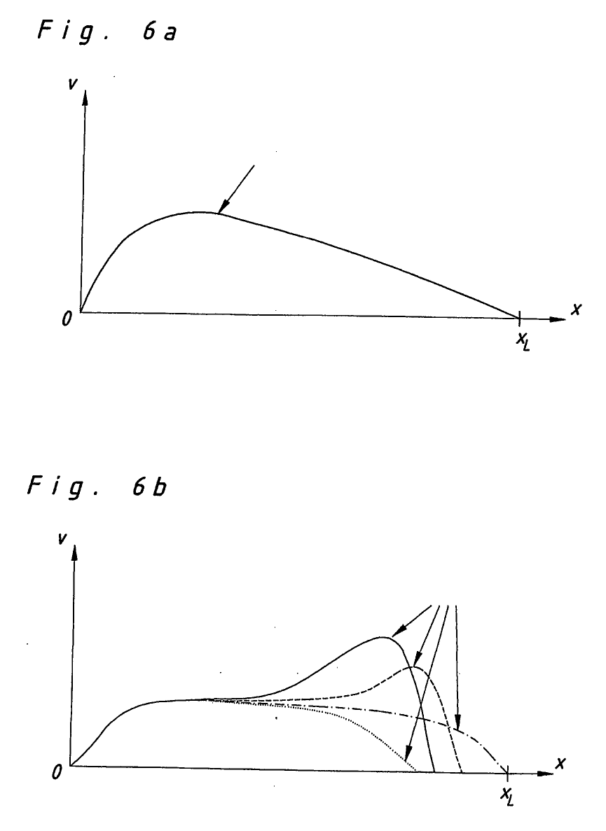

FIG. 6a, 6b speed-distance diagram of a movable furniture part driven by a drive according to the invention.

FIG. 1 shows an inventive drive 1 consisting of a motor 2, an engaging and disengaging clutch 3 and an output 4. A measurement device 6, the signals from which can be fed via the cable 22 to a control or regulation unit 5, is coupled with the output 4. The control or regulation unit 5 communicates via cables 20, 21 with the engaging and disengaging clutch 3 and/or the motor 2. There is also an additional clutch 15 provided for axial tolerance compensation (to correct installation errors and similar). The motor 2, the clutch 15, the engaging and disengaging clutch 3, the output 4 and the measurement device 6 are disposed along an imaginary line. The exertion of force on the movable furniture part 7, which in the present case takes the form of a drawer, occurs via a traction mechanism 8, in this case in the form of a cable pull via a carrier, not shown in FIG. 1, which is attached inside the movable furniture part 7. The traction mechanism 8 runs via the output 4, a roller shown in FIG. 4b and a deflection pulley 19.

In FIG. 2a, a perspectival view of a concrete embodiment of a drive 1 is shown. In this embodiment it is possible to see the motor 2, which is in the form of an electromotor, the clutch 15 displaying a compressible area for the axial tolerance compensation, the engaging and disengaging clutch 3, the output 4 and an encoder 16. In this embodiment, shafts 10 and 11 respectively are disposed along the imaginary line 9.

FIG. 2b shows the drive 1 from FIG. 2a in a top view, whereby an installation housing 20 can also be seen.

In FIG. 3, the drive 1 is recognisable in installed condition on a distance plate 23 disposed in a furniture body 13. Of the movable furniture part 7, only the rear wall 18 is partially shown. It can be seen that the coupling of the movable furniture part 7 to the traction mechanism 8 is realised via a carrier 17 disposed on the rear wall 18.

In FIG. 4a, a perspectival partial view of the view shown in FIG. 3 is shown. FIG. 4b shows by way of example one option for power transmission from the drive 4 to the carrier 17. The traction mechanism 8 loops around the roller of the drive 4 several times and is guided via the roller 24 and the deflection pulley 19.

FIG. 5 shows the total view of a piece of furniture with the arrangement shown in FIG. 3.

FIGS. 6a and 6b show by way of example the speed v of a movable furniture part 7 as a function of the distance covered x. On the x-axis x=0 refers to the closed final position of the movable furniture part 7 in the furniture body 13 and x=x_{L} means the fully-open final position of the movable furniture part 7.

FIG. 6a shows the speed course when opening the movable furniture part 7. The arrow shows the point at which the control or regulation unit 5 disengages the engaging and disengaging clutch 3. From this point on, the speed of the movable furniture part 7 reduces due to friction forces intrinsic to the system. The exertion of force on the movable furniture part 7 is precisely selected in the example shown in FIG. 6a so that an empty movable furniture part 7, under the initial acceleration and the effect of the friction forces, moves until it reaches the fully-open end position.

FIG. 6b shows the course of the speed v in the closing process of a movable furniture part 7. By way of example, different speed courses have been shown here. The arrows each designate the point at which the control or regulation unit 5 engages the engaging and disengaging clutch 3. From the right of this point in FIG. 6b, the increase in speed occurs through manual exertion of force by a user. The curves thereby differ from each other due to the strength of the manual impulse (different increases of the curves) and different initial positions of the movable furniture part 7 (intersection points of the curves with the x-axis).

In FIG. 6b it can be seen that the control or regulation unit 5 regulates the motor 2 in such a way that regardless of the strength of the initial impulse, the same speed is attained at a certain distance from the fully-open end position. In this embodiment the speed is reduced to 0 in the area of the closed end position for all curves by the motor 2. Alternatively, the clutch 3 could be disengaged by the control or regulation unit 5 at a pre-defined position before the closed end position so that the movable furniture part 7 is moved into the closed end position and at the same time braked by an available automatic retraction device.

1. Drive for a movable furniture part, comprising a motor and an output drivable by the motor for the movable furniture part, a control or regulation unit and a measuring device for capturing the position and/or quantities of motion of the movable furniture part, wherein the measurement signals from the measuring device can be transmitted to the control or regulation unit and wherein a clutch co-operating with the motor and the output is provided, the clutch being designed such that it can be engaged and disengaged by the control and regulation unit, wherein he clutch can be engaged and disengaged by the control and regulation unit in dependence on the measurement signals from the measuring device.

2. Drive according to claim 1, wherein the clutch is designed such that the strength of the clutch force can be modified.

3. Drive according to claim 2, wherein the clutch is designed such that the modification of the clutch force follows a pre-set profile when transitioning between the disengaged state and the engaged state.

4. Drive according to claim 1, wherein the clutch is designed as an electromagnetic clutch.

5. Drive according to claim 4, wherein the clutch is designed such that it is disengaged in currentless condition.

6. Drive according to claim 1, wherein the measuring device includes an encoder, where the encoder is preferably coupled with the output.

7. Drive according to claim 1, wherein the output co-operates with the movable furniture part via a traction mechanism.

8. Drive according to claims 1, wherein the motor, the clutch and the output are disposed along an imaginary line with the clutch disposed between motor and output.

9. Drive according to claim 8, wherein a shaft is disposed along the line between motor and clutch on the one hand and between clutch and output on the other respectively.

10. Drive according to claim 1, wherein the motor co-operates with the clutch via a set of gears.

11. Drive according to claim 1, wherein the motor is in the form of an electromotor.

12. Drive according to claim 1, wherein the movable furniture part is a drawer.

13. Furniture with a furniture body and a furniture part displaceably mounted in or on the body, comprising a drive according to claim 1.

14. Furniture according to claim 13, wherein the control or regulation unit is designed such that it disengages the clutch when the movable furniture part is at a distance from the furniture body and displays a speed which is less than or equal to a pre-set value—preferably equal to zero.

15. Furniture according to claim 13, wherein a collision detection device is provided for the movable furniture part and that the control or regulation unit is designed such that it disengages the clutch when the collision detection device reports a collision.

16. Furniture according to claim 13, wherein in addition, an automatic retraction device is provided, which is designed such that it can retract the movable furniture part into its closed final position in or on the furniture body.

17. Furniture according to claim 13, wherein the control or regulation unit is designed such that it has a threshold value in relation to the quantities of motion and/or of the position of the movable furniture part transmitted by the measuring device, whereby the control or regulation unit triggers the movement of the movable furniture part if the threshold value is exceeded and that the threshold value varies in its level for at least two positions of the movable furniture part.
